(19) United States
(12) Patent Application Publication
(10) Pub. No.: US 2015/0006921 A1
(43) Pub. Date: Jan. 1, 2015

(54) POWER SUPPLY ADAPTOR AND METHOD FOR SWITCHING BETWEEN POWER SUPPLES

(71) Applicant: HON HAI PRECISION INDUSTRY CO., LTD., New Taipei (TW)

(72) Inventors: PO-ERH SHIH, New Taipei (TW); HSIANG-PIN TSENG, New Taipei (TW)

(21) Appl. No.: 14/313,729

(22) Filed: Jun. 24, 2014

(30) Foreign Application Priority Data
Jun. 28, 2013 (TW) 102123390

(51) Int. Cl. G06F 1/26

(52) U.S. Cl. CPC G06F 1/263
USPC 713/300

(57) ABSTRACT

A power supply adaptor includes more than one path to an output terminal electrically coupled to and powering a load, and can switch between paths according to the level of current being drawn by the load. In addition to first and second power supply paths, there is a switch controller, and a determining module. The first power supply path is electrically coupled to the output terminal and provides a first voltage. The second power supply path includes a battery and the battery provides a second voltage. The determining module connects to the switch controller. The determining module detects a first current of the first power supply path and a second current of the second supply path to determine the electrical load being drawn. The switch controller switches between the first switch and the second switch according to the electrical load.

### FIELD

The present disclosure relates to a power supply adaptor and a method for switching between power supplies.

### BACKGROUND

Portable devices and laptop computers have different power supply requirements when processing different working loads. For example, when a 3D-game is being processed, a large power output is required, and when a device is in sleep mode, only small power output is needed. An output current change according to different working loads.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block view of an example embodiment of a power supply adaptor.

FIG. 2 is a flow chart of an example method for switching between power supplies according to an example embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

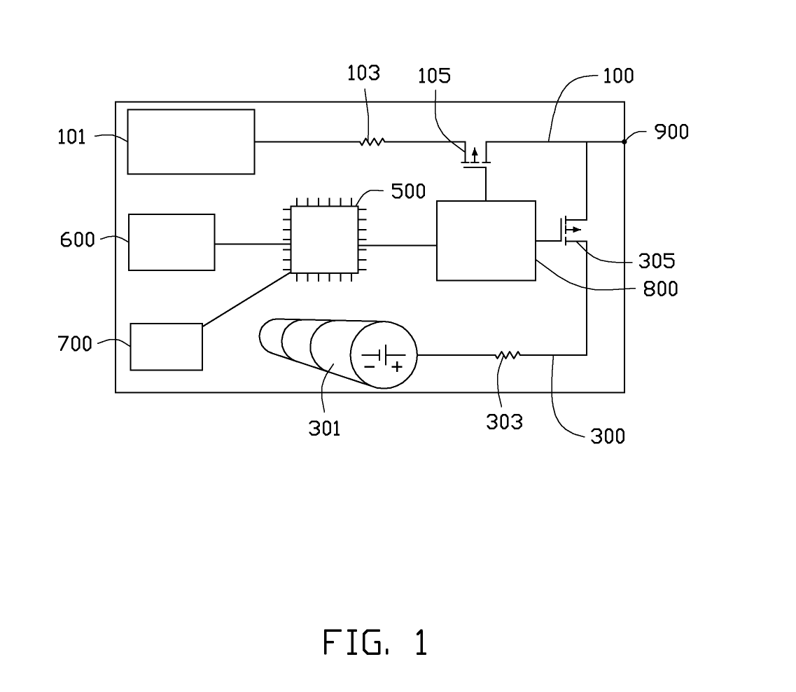

FIG. 1 illustrates an example embodiment of a block view of a power supply adaptor. The adaptor can comprise a first power supply path 100, a second power supply path 300, a determining module 500, a battery monitor 600, a charger 700, and a switch controller 800. The first power supply path 100 and the second power supply path 300 are connected to an output terminal 900 to supply power to a load. The adaptor can be a power supply circuit used in an electronic device, such as laptop computer or other portable device.

The first power supply path 100 can provide a large output for a heavy load. The first power supply path 100 includes a power supply 101, a first discharging sensor 103, and a first switch 105. The power supply 101, the first discharging sensor 103, and the first switch 105 are connected to the output terminal 900 in series. The power supply 101 includes an AC to DC converter. The power supply 101 can provide a voltage, such as from about 19V to about 20V. The first discharge sensor 103 can be a resistor.

The second power supply path 300 can provide a smaller output for a light load. The second power supply path 300 includes a battery 301, a second discharging sensor 303, and a second switch 305. The battery 301, the second discharging sensor 303, and the second switch 305 are connected to the output terminal 900 in series. The battery 301 can provide a voltage approximately 6V. The switch controller 800 is connected to the battery monitor 600 and the charger 700. The battery monitor 600 can monitor a power state of the battery 301. The determining module 500 can control the charger 700 to charge the battery 301 powered by the power supply 101. The second discharging sensor 303 can be a resistor.

The determining module 500 is connected to the first discharging sensor 103 and the second discharging sensor 303. The switch controller 800 can control the first switch 105 and the second switch 305. The determining module 500 can detect a first current of the first discharging sensor 103 when the first switch 105 is switched on. The determining module 500 can also detect a second current of the second discharging sensor 303 when the second switch 305 is switched on, to determine if a load is heavy load or a light load. The switch controller 800 can switch between the first switch 105 and the second switch 305 if the load is determined.

The determining module 500 can switch on the second switch 305 and switch off the first switch 105 simultaneously if the first current is smaller than a first predefined current. The determining module 500 can also switch on the first switch 105 and switch off the second switch 305 simultaneously if the second current is greater than a second predefined current. The first predefined current and the second predefined current can be defined by a user. The second predefined current is equal to or greater than the first predefined current. The first current can be approximately greater than or equal to 0.5 A. The second current can be from approximately 0.1 A to 0.3 A.

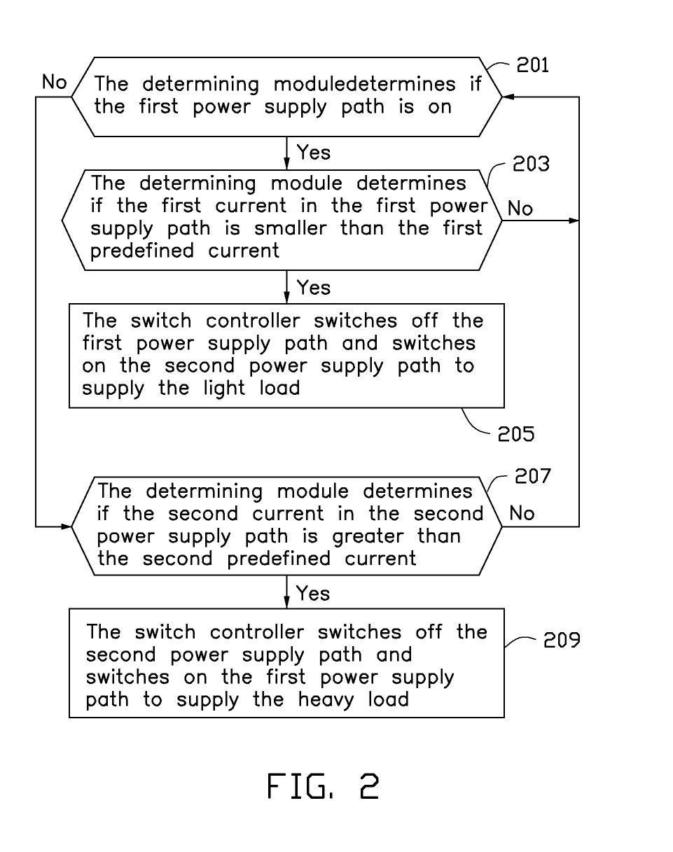

FIG. 2 illustrates a flowchart of an example method for switching between power supplies. The method includes the following steps or blocks, which can be arranged in the order illustrated or in a different order. The method can include additional steps that are not illustrated and in one or more embodiments one or more steps can be eliminated.

In block 201, a determining module determines if the first power supply path is on. If the first power supply is on, then the method proceeds to block 203. If the first power supply is not on, the method proceeds to block 207.

In block 203, the determining module determines if a first current in a first power supply path is less than a first predefined current. If the first current is less than the predefined current, the method can proceed to block 205. If the first current is not less than the predefined current, the method can proceed to block 201.

In block 205, a switch controller switches off the first power supply path and switches on a second power supply path to supply a load.

In block 207, the determining module determines if a second current in the second power supply path is greater than a second predefined current. If the second current is greater than the second predefined current, the method can proceed to block 209. If the second current is not greater than the second predefined current, the method can proceed to block 201.

In block 209, a switch controller switches off the second power supply path and switches on the first power supply path to supply the load.

Even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A power supply adaptor, comprising:
an output terminal electrically coupled to a load;
a first power supply path electrically coupled to the output terminal for providing a heavy load, comprising a power supply providing a first voltage, a first discharging sensor, and a first switch;
a second power supply path connecting to the output terminal for providing a light load, the second power supply path comprising a battery providing a second voltage smaller than the first voltage, a second discharging sensor, and a second switch;
a switch controller, electrically coupled to the first switch and the second switch;
a determining module, electrically coupled to the first discharging sensor and the second discharging sensor;
the determining module configured to detect a first current of the first discharging sensor and a second current of the second discharging sensor to determine the load being the light load or heave load;
and the switch controller configured to switch on the first switch if the heavy load is determined, or switch on the second switch if the light load is determined.

2. The power supply adaptor of claim 1, wherein the first voltage is from between 19 Volts to about 20 Volts.

3. The power supply adaptor of claim 2, wherein the second voltage is approximately 6 Volts.

4. The power supply adaptor of claim 2, wherein the power supply comprises an AC to DC converter.

5. The power supply adaptor of claim 1, wherein the determining module is electrically coupled to a battery monitor configured to monitor a power state of the battery, and a charger is configured to charge the battery powered by the power supply.

6. The power supply adaptor of claim 1, wherein the determining module is configured to switch on the second switch and switch off the first switch simultaneously if the first current is smaller than a first predefined current.

7. The power supply adaptor of claim 6, wherein the determining module is configured to switch on the first switch and switch off the second switch simultaneously if the second current is greater than a second predefined current.

8. The power supply adaptor of claim 7, wherein the second predefined current is greater than the first predefined current.

9. A power supply adaptor, comprising:
an output terminal electrically coupled to a load;
a first power supply path electrically coupled to the output terminal, comprising a power supply providing a first voltage;
a second power supply path electrically coupled to the output terminal, the second power supply path comprising a battery providing a second voltage;
a switch controller; and
a determining module electrically coupled to the switch controller;
the determining module configured to detect a first current of the first power supply path and detect a second current of the second power supply path to determine if the load is a heavy load or a light load,
and the switch controller configured to switch on the first switch if the heavy load is determined, or switch on the second switch if the light load is determined.

10. The power supply adaptor of claim 9, wherein the second voltage is smaller than the first voltage.

11. The power supply adaptor of claim 10, wherein the determining module is configured to switch on the second switch and switch off the first switch simultaneously if the first current is smaller than a first predefined current.

12. The power supply adaptor of claim 11, wherein the determining module is configured to switch on the first switch and switch off the second switch simultaneously if the first current is greater than a second predefined current.

13. The power supply adaptor of claim 12, wherein the second predefined current is greater than the first predefined current.

14. A method for switching between power supplies, comprising:
providing a first power supply path and a second power supply path, wherein the first power supply path comprises a power supply providing a first voltage, the second power supply path comprising a battery providing a second voltage, wherein, the second voltage is smaller than the first voltage;
determining if the first power supply path is on;
if the first power supply path is on, determining if a first current in the first power supply path is less than a first predefined current;
if the first current path is less than the first predefined current, switching off the first power supply path and switching on the second power supply path;
determining if a second current in the second power supply path is greater than a second predefined current; and
switching on the first power supply path and switching off the second power supply path.

15. The method of claim 14, wherein the second predefined current is greater than the first predefined current.

16. The method of claim 14, wherein the first voltage is about from 19V to 20V.

17. The method of claim 16, wherein the second voltage is about 6V.

18. The method of claim 14, wherein the power supply comprises an AC to DC converter.
